(19) United States
(12) Patent Application Publication
(10) Pub. No.: US 2014/0041393 A1
(43) Pub. Date: Feb. 13, 2014

(54) SYSTEMS AND METHODS FOR PROCESSING INLET AIR

(71) Applicants: Bhalchandra Arun Desai, Smyrna, GA (US); Julio Enrique Mestroni, Marietta, GA (US); Huong Van Vu, Duluth, GA (US)

(72) Inventors: Bhalchandra Arun Desai, Smyrna, GA (US); Julio Enrique Mestroni, Marietta, GA (US); Huong Van Vu, Duluth, GA (US)

(21) Appl. No.: 13/569,844

(22) Filed: Aug. 8, 2012

(51) Int. Cl. F02C 7/04; B01D 53/08

(52) U.S. Cl. 60/779; 60/39.093; 96/118; 95/91

(57) ABSTRACT

An air processing assembly is provided. The assembly includes at least one filter element that includes a filter media having a first end and a second end spaced a predefined distance from the first end. A channel is defined within the filter media, wherein the channel extends from the filter media first end to the filter media second end. The channel defines a flow path for a solid desiccant, wherein air being channeled through the assembly is filtered via the filter media and moisture is substantially removed from the air via the solid desiccant.

### BACKGROUND OF THE INVENTION

The field of the invention relates generally to systems and, more particularly, to an air processing assembly that may be used to filter and remove moisture from inlet air used with such systems.

At least some known systems, such as, but not limited to, power systems, use ambient air during operation of the system. For example, at least some known power systems include at least one gas turbine engine that uses a mixture of fuel and air for combustion. More specifically, the gas turbine engine includes an inlet that enables ambient air to enter a compressor, wherein the air is compressed to a suitable pressure for combustion with the fuel in a combustor. Prior to entering the compressor, the ambient air may be filtered via a filtration system and/or cooled via an inlet cooling system.

However, the temperature and humidity of the ambient air can vary due to, for example, the geographic location of the power system, seasonal changes. In some locations, the temperature of the ambient air may drop below approximately 45° degrees Fahrenheit. Such a relatively low temperature may cause the dew point of the air to lower to a level wherein the air becomes saturated. As a result, moisture within the air may form into ice under the flow conditions inside the inlet system. When ice is ingressed into the compressor, the ice may cause damage to the compressor and/or other components of the gas turbine engine. Continued operation of the gas turbine engine with damaged components may cause damage to other components and/or may lead to a premature failure of the gas turbine engine.

To prevent damage from ice, for example, at least some known power systems may use control systems and/or heating coils to regulate the temperature of the ambient air. When using a control system, hot air from the gas turbine compressor may be used to heat the ambient air. However, known control systems rely on good quality air to heat the ambient air, as opposed to the using the air towards the mechanics in generating energy. Accordingly, the use of such systems may be inefficient. There are methods that use electrical heating coils which heat the inlet air but they add parasitic loads.

The presence of moisture in the inlet air is a cause for ice formation and this method details the way to remove the moisture from inlet air.

In addition to ice formation, high humid air in combination with dust in the air stream forms dirt cakes on the air filters and clogs up the air passage. When this occurs it causes the gas turbine to stall.

### BRIEF DESCRIPTION OF THE INVENTION

In one embodiment, an air processing assembly is provided. The assembly includes at least one filter element that includes a filter media having a first end and a second end spaced a predefined distance from the first end. A channel is defined within the filter media, wherein the channel extends from the filter media first end to the filter media second end. The channel defines a flow path for a solid desiccant, wherein air being channeled through the assembly is filtered via the filter media and moisture is substantially removed from the air via the solid desiccant.

In another embodiment, a system is provided. The system includes a turbine engine that includes a compressor and an air processing assembly coupled to the compressor. The assembly includes at least one filter element that includes a filter media having a first end and a second end spaced a predefined distance from the first end. A channel is defined within the filter media, wherein the channel extends from the filter media first end to the filter media second end. The channel defines a flow path for a solid desiccant, wherein air being channeled through the assembly is filtered via the filter media and moisture is substantially removed from the air via the solid desiccant.

In yet another embodiment, a method of processing air is provided. Air is supplied to an air processing assembly that includes at least one filter element positioned within the assembly. The filter element includes a filter media that includes a first end and a second end spaced a predefined distance from the first end. The air is channeled to the filter element. The air is filtered when the air is channeled through at least a portion of the filter media. The air is channeled to a channel defined within the filter media, wherein the channel extends from the filter media first end to the filter media second end. A solid desiccant is distributed within a flow path defined within the channel such that moisture is substantially removed from the air via the solid desiccant.

### BRIEF DESCRIPTION OF THE DRAWINGS

FIG. 1 is a block diagram of an exemplary system;

FIG. 2 is a block diagram of an exemplary air processing assembly that may be used with the system shown in FIG. 1 and taken from area 2;

FIG. 3 is an enlarged view of a portion of the air processing assembly shown in FIG. 2 and taken from area 3;

FIG. 4 is a block diagram of an alternative air processing assembly that may be used with the system shown in FIG. 1 and taken from area 2; and

FIG. 5 is an enlarged view of a portion of the air processing assembly shown in FIG. 4 and taken from area 5.

### DETAILED DESCRIPTION OF THE INVENTION

The exemplary apparatus, systems, and methods described herein overcome at least some known disadvantages associated with at least some known systems that use ambient air by providing an air processing assembly that filters and dehumidifies ambient air prior to its use within the system. More specifically, the assembly includes at least one filter element that enables inlet air to be filtered. Moreover, in the exemplary embodiment, the assembly channels a solid desiccant to be distributed within the filter element to facilitate removing moisture from the inlet air. Because of the simultaneous filtration and moisture removal from the inlet air, the temperature of the inlet air can be substantially reduced without ice formation by the use of inlet air cooling techniques.

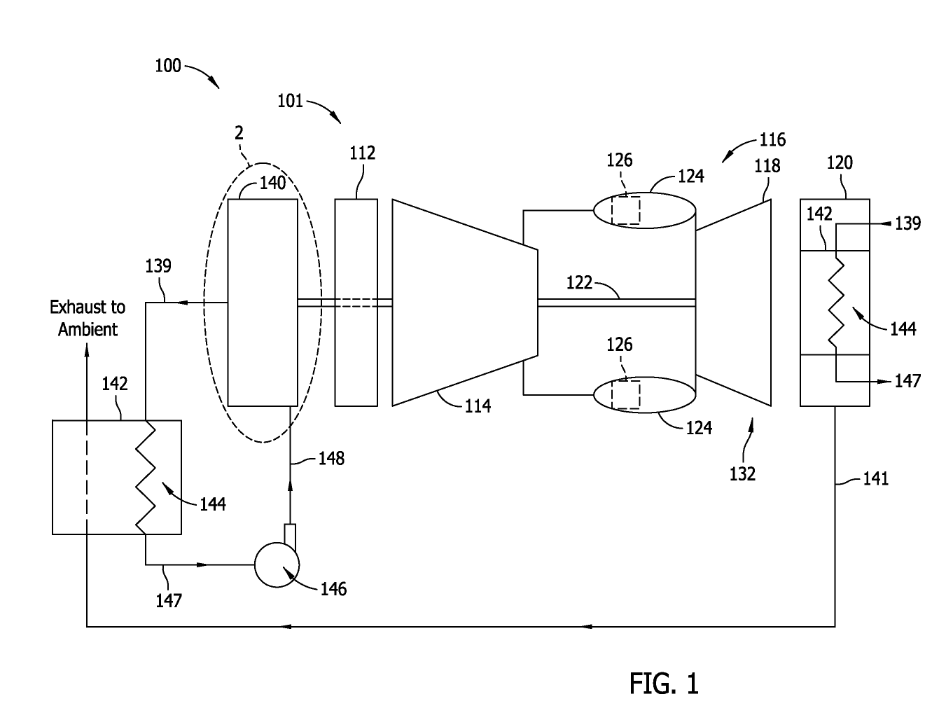

FIG. 1 illustrates a portion of an exemplary system 100. In the exemplary embodiment, system 100 is a power system 100. Power system 100 may be an integrated gasification combined-cycle (IGCC) plant or any other type of power system. Although the exemplary embodiment illustrates a power system, the present disclosure is not limited to power systems, and one of ordinary skill in the art will appreciate that the current disclosure may be used in connection with any type of system. In the exemplary embodiment, power system 100 includes a turbine engine 101. More specifically, in the exemplary embodiment, turbine engine 101 is a gas turbine engine. While the exemplary embodiment includes a gas turbine engine, the present invention is not limited to any one particular engine, and one of ordinary skill in the art will appreciate that the current invention may be used in connection with other turbine engines.

Moreover, in the exemplary embodiment, turbine engine 101 includes an inlet or intake section 112, a compressor section 114 downstream from intake section 112, a combustor section 116 downstream from compressor section 114, a turbine section 118 downstream from combustor section 116, and an exhaust section 120. In the exemplary embodiment, turbine section 118 is coupled to compressor section 114 via a rotor shaft 122. It should be noted that, as used herein, the term “couple” is not limited to a direct mechanical, thermal, communication, and/or an electrical connection between components, but may also include an indirect mechanical, thermal, communication and/or electrical connection between multiple components.

In the exemplary embodiment, combustor section 116 includes a plurality of combustors 124. Combustor section 116 is coupled to compressor section 114 such that each combustor 124 is positioned in flow communication with the compressor section 114. A fuel injection assembly 126 is coupled within each combustor 124. Turbine section 118 is coupled to compressor section 114 and to a load (not shown) such as, but not limited to, an electrical generator and/or a mechanical drive application. In the exemplary embodiment, each compressor section 114 and turbine section 118 includes at least one rotor disk assembly (not shown) that is coupled to a rotor shaft 122 to form a rotor assembly 132.

In the exemplary embodiment, intake section 112 is coupled to an air processing assembly 140. As explained in more detail below, assembly 140 filters air, such as inlet air (i.e., air being channeled to intake section 112 to be used by turbine engine 101), and substantially removes moisture from the inlet air. An inlet chiller system (not shown) that includes, for example, a chilling coil (not shown) may be coupled between intake section 112 and assembly 140 to substantially cool the inlet air.

A regenerator 142, in the exemplary embodiment, is coupled to assembly 140 and to exhaust section 120, via fluid conduits 139 and 141, respectively. Alternatively, regenerator 142 may be positioned within exhaust section 120, as shown in FIG. 1. In the exemplary embodiment, regenerator 142 is configured to store and provide a solid desiccant (not shown in FIG. 1), such as silica gel beads, to assembly 140. In the exemplary embodiment, regenerator 142 includes a plurality of plates 144 to define a flow path for the solid desiccant. More specifically, in the exemplary embodiment, each plate 144 is positioned adjacent to at least one other plate 144 such that the plurality of plates 144 are arranged in a zigzag formation with a path defined that enables the solid desiccant to flow along the surfaces of the plates 144. Alternatively, the plurality of plates 144 may be arranged in any other suitable orientation that enables power system 100 to function as described herein. A pump 146 is coupled to regenerator 142 via a conduit 147. Pump 146 is also coupled to assembly 140 via a conduit 148. In the exemplary embodiment, pump 146 is a solid feed pump that channels the solid desiccant from regenerator 142 to assembly 140. Alternatively, pump 146 may be any suitable pump that enables power system 100 to function as described herein.

During operation, intake section 112 channels air towards compressor section 114, wherein the air is compressed to a higher pressure prior to being discharged towards combustor section 116. The compressed air is mixed with fuel and other fluids that are provided by each fuel injection assembly 126 and the mixture is ignited to generate combustion gases that are channeled towards turbine section 118. More specifically, each fuel injection assembly 126 injects fuel, such as natural gas and/or fuel oil, air, and/or diluents in respective combustors 124, and into the air flow. The blended mixtures are ignited to generate high temperature combustion gases that are channeled towards turbine section 118. Turbine section 118 converts the thermal energy from the gas stream to mechanical rotational energy, as the combustion gases impart rotational energy to turbine section 118 and to rotor assembly 132.

In the exemplary embodiment, the air is processed within assembly 140, prior to the air being channeled to towards compressor section 114. As explained in more detail below, in the exemplary embodiment, the air is channeled through a plurality of filter elements (not shown in FIG. 1) such that the air is filtered from, for example, contaminants. Moreover, as the air is channeled through the filter elements, the solid desiccant is channeled from regenerator 142, via pump 146, to assembly 140. More specifically, in the exemplary embodiment, the solid desiccant is gravity fed through the filter elements. Alternatively, the solid desiccant may be channeled through the filter elements without gravity.

When the air is in contact with the solid desiccant, the solid desiccant substantially removes moisture from the air. The air may also then be channeled to, for example, the inlet chiller system such that the air may be cooled. The filtered and dehumidified air is then channeled to compressor section 114. Because of the filtration and because the moisture is substantially removed from the air, filtered and dried air is enabled to be channeled to the compressor. The filtered and dried air substantially prevents erosion or ice formation.

The solid desiccant containing the moisture is then channeled back to regenerator 142 via conduit 139. At the same time, exhaust from exhaust section 120 is channeled to regenerator 142 via conduit 141. The heated exhaust air facilitates substantially removing moisture from the solid desiccant. More specifically, when the exhaust is in contact with the solid desiccant, the exhaust is able to remove the moisture from the solid desiccant. As such, the solid desiccant may then be channeled back to assembly 140 and used again to substantially remove moisture from the air. As such, assembly 140 facilitates an efficient process for the processing of the air before it is used by turbine engine 101. Moreover, if the inlet chiller system or any other indirect inlet cooling system is coupled between intake section 112 and assembly 140, having the air be processed via assembly 140, prior to entering the chiller system, substantially reduces the load induced on the chilling coil or the chilling machine. While the exemplary embodiment uses exhaust fluid to remove moisture from the solid desiccant, any suitable fluid may be used to remove the moisture.

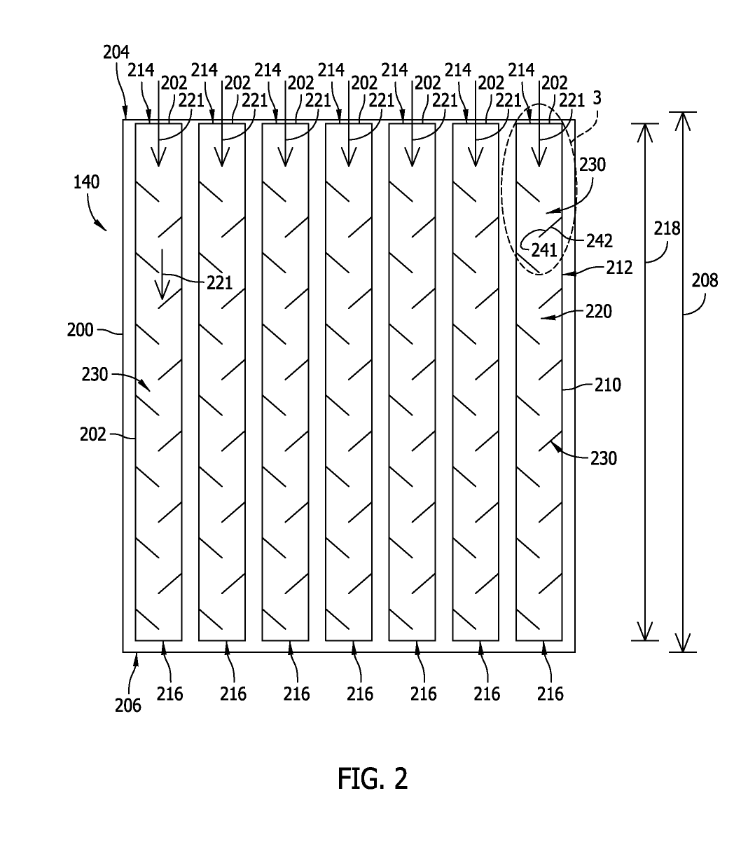

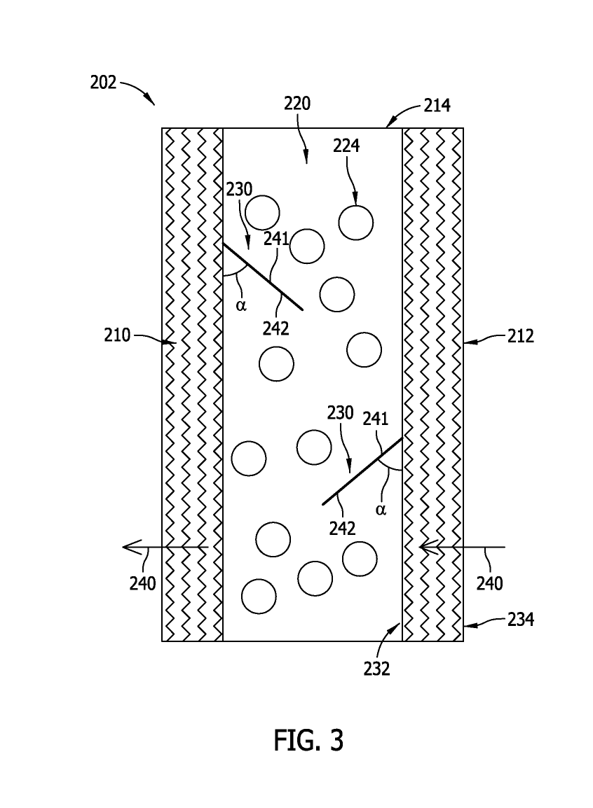

FIG. 2 is a block diagram of air processing assembly 140 taken from area 2 (shown in FIG. 1). FIG. 3 is an enlarged view of a portion of assembly 140 taken from area 3 (shown in FIG. 2). In the exemplary embodiment, assembly 140 includes a housing 200 that substantially encloses a plurality of filter elements 202 therein. In the exemplary embodiment, housing 200 includes a first end surface 204 and a second end surface 206 spaced a predefined distance 208 from first end surface 204. In the exemplary embodiment, housing 200 is substantially cylindrical such that housing 200 substantially circumscribes filter elements 202. Alternatively, housing 200 may have any suitable shape that enables assembly 140 and/or power system 100 (shown in FIG. 1) to function as described therein.

In the exemplary embodiment, filter elements 202 are aligned substantially parallel with respect to each other. Moreover, each filter element 202 is substantially vertical with respect to each of the first end surface 204 and second end surface 206. Alternatively, filter elements 202 may be oriented in any other manner that enables assembly 140 and/or power system 100 to function as described herein. Each filter element 202, in the exemplary embodiment, is substantially cylindrical. Alternatively, filter elements 202 may have any suitable shape that enables assembly 140 and/or power system 100 to function as described herein.

Each filter element 202 includes a filter media 210 that is contained within each filter element 202 via an air permeable cover 212. In the exemplary embodiment, cover 212 may be fabricated from, for example, a wire mesh. Alternatively, cover 212 may be fabricated from any suitable material that enables assembly 140 and/or power system 100 to function as described herein. Filter media 210, in the exemplary embodiment, may be a porous filter media such that air may be filtered when the air is channeled therethrough. More specifically, in the exemplary embodiment, filter media 210 may be any suitable filter media that is sized to be accommodated within filter element 202, such as an annular filter cartridge or sheet that has a first end 214 and a second end 216 positioned a predefined distance 218 from first end 214. Moreover, in the exemplary embodiment, filter media 210 may include at least one membrane (not shown), such as, for example, a polyethersulfone (PESU) membrane or an expanded polytetraflouroethylene (ePTFE) membrane. Alternatively, filter media 210 may include any other type of suitable porous membrane that may be fabricated from organic materials, such as polymers and liquids, as well as inorganic materials having a suitable pore size.

In the exemplary embodiment, a channel 220 is defined within filter media 210 and extends from filter media first end 214 to filter media second end 216. Channel 220 defines a flow path, as shown by arrows 221, for a solid desiccant 224. In the exemplary embodiment, solid desiccant 224 includes silica gel beads that are able to adsorb moisture from, for example, the air during contact. Alternatively, solid desiccant 224 may be any suitable material that is able to adsorb moisture.

A plurality of plates 230 are positioned within channel 220 and coupled to filter media 210. More specifically, in the exemplary embodiment, each plate 230 is coupled to filter media 210 and extends outwardly towards channel 220. Filter media 210 includes an interior surface 232 that defines channel 220 and an opposing exterior surface 234 that is adjacent to cover 212. Each plate 230 is coupled to interior surface 232 and extends outwardly towards channel 220 at an angle a such that each plate 230 is oblique with respect to interior surface 232. Each plate 230 has a first surface 241 and an opposing second surface 242, wherein solid desiccant 224 is channeled along first surface 241 of each plate 230. The angle a can be of any degree and various guide members (not shown) may be used in place of plates 230.

During operation, air is processed within assembly 140, prior to the air being channeled to compressor section 114 (shown in FIG. 1). In the exemplary embodiment, the air is channeled through each filter element 202. More specifically, the air is channeled through cover 212 and through exterior surface 234 of filter media 210 such that the air is supplied into channel 220. When the air is channeled through filter media 210, the air is filtered such that contaminants within the air are substantially removed and remains within media 210.

As the inlet air is being channeled through each filter element 202, the solid desiccant is channeled into filter element 202 and distributed within filter element 202 as well. More specifically, in the exemplary embodiment, solid desiccant 224 is channeled from regenerator 142 (shown in FIG. 1) to pump 146 (shown in FIG. 1) via conduit 147 (shown in FIG. 1). Solid desiccant 224 is then pumped into assembly 140, via pump 146, through conduit 148 (shown in FIG. 1). Solid desiccant 224 is then channeled through each filter element 202 from filter media first end 214 to filter media second end 216. More specifically, solid desiccant 224 is channeled within channel 220 via gravity. As solid desiccant 224 is channeled within channel 220, solid desiccant 224 is channeled along first surface 241 of each plate 230. Moreover, when the air is in contact with solid desiccant 224, moisture is substantially removed from the air by solid desiccant 224. More specifically, moisture within the air is adsorbed by solid desiccant 224. Accordingly, the air is filtered and moisture is substantially removed from the air when the air is channeled through assembly 140.

Solid desiccant 224 containing the moisture is channeled from assembly 140 back to regenerator 142 via conduit 139 (shown in FIG. 1). At the same time, exhaust from turbine engine exhaust section 120 is channeled to regenerator 142. The exhaust facilitates the removal of the moisture from solid desiccant 224. More specifically, the exhaust removes the moisture from solid desiccant 224 such that solid desiccant 224 can be channeled back to assembly 140 and used again.

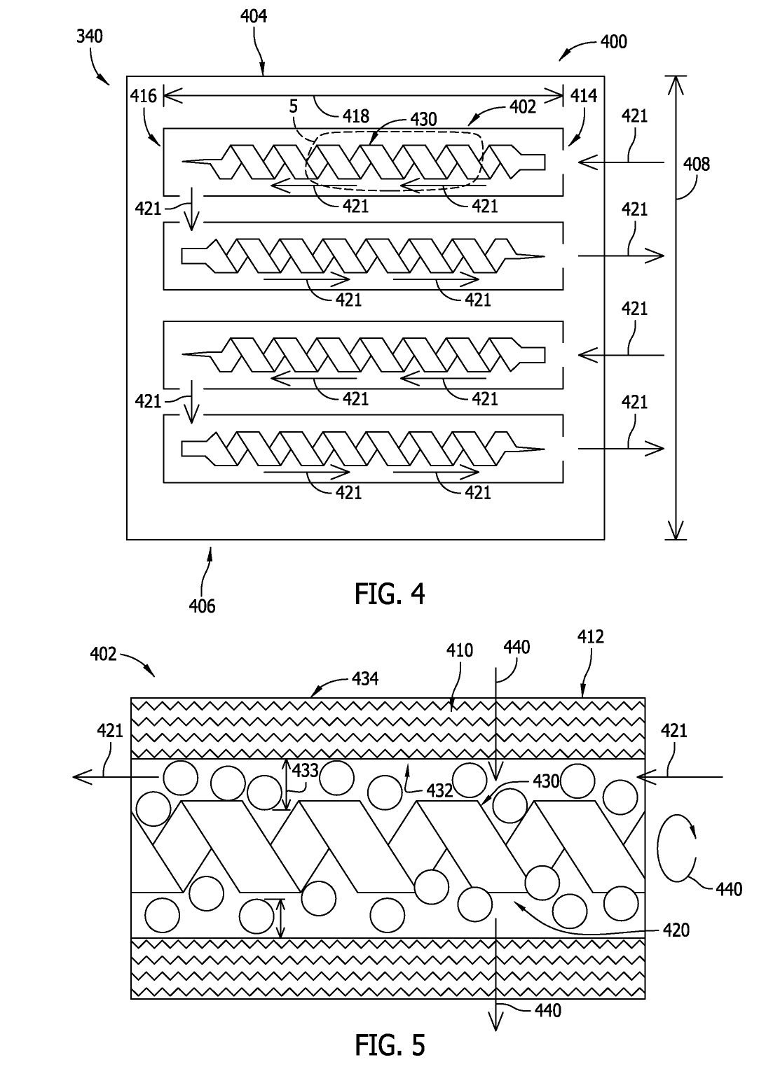

FIG. 4 illustrates an alternative air processing assembly 340 that may be used with power system 100 (shown in FIG. 1) and taken from area 2 (shown in FIG. 1) in place of assembly 140 (shown in FIGS. 1, 2, and 3). FIG. 5 is an enlarged view of a portion of assembly 340 and taken from area 5 (shown in FIG. 4). In the exemplary embodiment, assembly 340 includes a housing 400 that substantially encloses a plurality of filter elements 402 therein. In the exemplary embodiment, housing 400 includes a first end surface 404 and a second end surface 406 positioned a predefined distance 408 from first end surface 404. In the exemplary embodiment, housing 400 is substantially cylindrical such that housing 400 substantially circumscribes filter elements 402. Alternatively, housing 400 may have any suitable shape that enables assembly 340 and/or power system 100 to function as described herein.

In the exemplary embodiment, filter elements 402 are aligned substantially parallel with respect to each other. Moreover, each filter element 402 is substantially horizontal with respect to each of the first end surface 404 and second end surface 406. Alternatively, filter elements 402 may be arranged in any other manner that enables assembly 340 and/or power system 100 to function as described herein. Each filter element 402, in the exemplary embodiment, is substantially cylindrical. Alternatively, filter elements 402 may have any other shape that enables assembly 340 and/or power system 100 to function as described herein.

Each filter element 402 includes a filter media 410 that is contained within each filter element 402 via an air permeable cover 412. In the exemplary embodiment, cover 412 may be fabricated from, for example, a wire mesh. Alternatively, cover 412 may be fabricated from any suitable material that enables assembly 340 and/or power system 100 to function as described herein. Filter media 410, in the exemplary embodiment, may be a porous filter media such that the inlet air may be filtered when the air is channeled therethrough. More specifically, in the exemplary embodiment, filter media 410 may be any suitable filter media that is sized to be received within filter element 402, such as an annular filter cartridge or sheet that has a first end 414 and a second end 416 positioned a predefined distance 418 from first end 414. Moreover, in the exemplary embodiment, filter media 410 may include at least one membrane (not shown), such as, for example, a polyethersulfone (PESU) membrane or an expanded polytetraflouroethylene (ePTFE) membrane. Alternatively, filter media 410 may include any other type of suitable porous membrane that may be fabricated from organic materials, such as polymers and liquids, as well as inorganic materials having a suitable pore size.

In the exemplary embodiment, a channel 420 is defined within filter media 410 and extends from filter media first end 414 and filter media second end 416. Channel 420 defines a flow path, as shown by arrows 421, for a solid desiccant 424. In the exemplary embodiment, solid desiccant 424 includes silica gel beads that are able to adsorb moisture from, for example, air, such as inlet air. Alternatively, solid desiccant 424 may be any suitable material that is able to adsorb moisture.

A rotating element 430 is positioned within channel 420 and coupled to filter media 410. More specifically, in the exemplary embodiment, rotating element 430 is coupled to filter media first end 414 and to filter media second end 416. Filter media 410 includes an interior surface 432 that defines channel 420 and an opposing exterior surface 434 that is adjacent to cover 412. In the exemplary embodiment, rotating element 430 is substantially circumscribed by interior surface 432 such that a distance 433 is defined between rotating element 430 and interior surface 432 within channel 420. In the exemplary embodiment, rotating element 430 rotates, as shown by arrow 440, to facilitate a rotational force to facilitate the flow of solid desiccant 424 within channel 420. Moreover, in the exemplary embodiment, rotating element 430 is substantially spiral shaped. Alternatively, rotating element 430 may be any suitable shape that enables assembly 340 and/or power system 100 to function as described herein. Rotating element 430 can also be powered by an external power source (not shown) to provide the rotational movement.

During operation, air is processed within assembly 340, prior to the air being channeled to compressor section 114 (shown in FIG. 1). In the exemplary embodiment, the air is channeled through each filter element 402. More specifically, the air is channeled through cover 412 and through the exterior surface 434 of filter media 410 such that the air is supplied into channel 420. When the air is channeled through filter media 410, the air is filtered such that contaminants within the air are substantially removed and remains within media 410.

As the air flows through each filter element 402, solid desiccant 424 is channeled into and distributed within filter element 402 as well. More specifically, in the exemplary embodiment, solid desiccant 424 is channeled from regenerator 142 (shown in FIG. 1) to pump 146 (shown in FIG. 1) via conduit 147 (shown in FIG. 1). Solid desiccant 424 is then pumped into assembly 340 via conduit 148 (shown in FIG. 1). Solid desiccant 424 is then channeled through each filter element 402 from filter media first end 414 to filter media second end 416. More specifically, rotating element 430 rotates to generate a rotational force that enables solid desiccant 424 to move within channel 420 from filter media first end 414 to filter media second end 416. As solid desiccant 424 is channeled through filter media first end 414 to filter media second end 416, the air comes into contact with solid desiccant 424. When the air and solid desiccant 424 are in contact with each other, moisture is substantially removed from the air by solid desiccant 424. That is, the moisture is adsorbed by solid desiccant 424. Accordingly, the air is filtered and moisture is substantially removed from the air when the air is channeled through assembly 340. As solid desiccant 424 flows from filter media first end 414 to filter media second end 416, the flow of desiccant 424 may be reversed by allowing the beads to drop into channel 420 via flow path 421. Rotating elements 430 in adjacent channels 420 rotate in opposite directions such that one rotating element 430 pushes desiccant 224 from filter media first end 414 to filter media second end 416 whereas another rotating element 430 pushes solid desiccant 224 from filter media second end 416 to filter media first end 414. As such, solid desiccant 424 is supplied and collected on the same side of housing 400. Alternatively, other suitable arrangements may be used to achieve the same effect.

Solid desiccant 424 containing the moisture are then channeled from assembly 340 to regenerator 142. At the same time, exhaust from turbine engine exhaust section 120 (shown in FIG. 1) is channeled to regenerator 142. The exhaust facilitates the removal of the moisture from solid desiccant 424. More specifically, the exhaust removes the moisture from solid desiccant 424 such that solid desiccant 424 can be channeled back to assembly 340 and used again. Alternatively, regenerator 142 can be located in exhaust section 120 itself and that would save some plant space. Also being in the exhaust section 120, the regeneration of desiccant 424 can improve the condition of the exhaust gas by releasing moisture in the exhaust gases and thus lowering the temperature of exhaust gases.

As compared to known apparatus and systems that are used with power systems to process ambient air, the above-described air processing assembly provides an efficient process for the filtration and the dehumidification of air, prior to the use of the air within the power system. The assembly includes at least one filter element that includes a filter media having a first end and a second end spaced a predefined distance from the first end. A channel is defined within the filter media, wherein the channel extends from the filter media first end to the filter media second end. The channel defines a flow path for a solid desiccant, wherein air being channeled through the assembly is filtered via the filter media and moisture is substantially removed from the air via the solid desiccant. Because of the simultaneous filtration and moisture removal from the inlet air, the dried and filtered air can be supplied to a compressor or an indirect inlet cooling equipment in an inlet section of the gas turbine.

Exemplary embodiments of apparatus, systems, and methods are described above in detail. The apparatus, systems, and methods are not limited to the specific embodiments described herein, but rather, components of the systems, apparatus, and/or steps of the method may be utilized independently and separately from other components and/or steps described herein. For example, the apparatus may also be used in combination with other systems and methods, and is not limited to practice with only a power system as described herein. Rather, the exemplary embodiment can be implemented and utilized in connection with many other systems.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An air processing assembly comprising at least one filter element comprising:
a filter media comprising a first end and a second end spaced a predefined distance from said first end; and
a channel defined within said filter media and said channel extending from said filter media first end to said filter media second end, said channel defines a flow path for a solid desiccant, air channeled through said assembly is filtered via said filter media and moisture is substantially removed from the air via the solid desiccant.

2. An air processing assembly in accordance with claim 1, wherein said at least one filter element comprises a plurality of filter elements that are aligned substantially parallel with respect to each other.

3. An air processing assembly in accordance with claim 1, further comprising a housing configured to substantially enclose said at least one filter element therein, wherein said housing comprises a first end surface and a second end surface spaced a predefined distance from said first end surface.

4. An air processing assembly in accordance with claim 3, wherein said at least one filter element is substantially vertical with respect to each of said housing first and second end surfaces, said at least one filter element further comprises one of a plurality of plates and a plurality of guide members coupled to said filter media, wherein one of each plate and each guide member extends outwardly from said filter media towards said channel such that each plate is positioned substantially within said channel, said plurality of plates facilitate the flow of the solid desiccant within said channel via gravity.

5. An air processing assembly in accordance with claim 3, wherein said at least one filter element is substantially horizontal with respect to said housing first and second end surfaces, said at least one filter element further comprises a rotating element positioned within said channel from said filter media first end to said filter media second end, wherein said rotating element facilitates a rotational force to facilitate the flow of the solid desiccant within said channel.

6. An air processing assembly in accordance with claim 5, wherein said rotating element is substantially spiral shaped.

7. An air processing assembly in accordance with claim 1, wherein said at least one filter element further comprises an air permeable cover to substantially contain said filter media therein.

8. An air processing assembly in accordance with claim 1, wherein said channel defines a flowpath for a silica gel.

9. A system comprising:
a turbine engine comprising a compressor; and
an air processing assembly coupled to said compressor, said assembly comprising at least one filter element comprising:
a filter media comprising a first end and a second end spaced a predefined distance from said first end; and
a channel defined within said filter media and said channel extending from said filter media first end to said filter media second end, said channel defines a flow path for a solid desiccant, air channeled through said assembly is filtered via said filter media and moisture is substantially removed from the air via the solid desiccant.

10. A system in accordance with claim 9, wherein said at least one filter element comprises a plurality of filter elements that are aligned substantially parallel with respect to each other.

11. A system in accordance with claim 9, wherein said assembly further comprises a housing configured to substantially enclose said at least one filter element therein, wherein said housing comprises a first end surface and a second end surface spaced a predefined from said first end surface.

12. A system in accordance with claim 11, wherein said at least one filter element is substantially vertical with respect to each of said housing first and second end surfaces, said at least one filter element further comprises one of a plurality of plates and a plurality of guide members coupled to said filter media, wherein one of each plate and each guide member extends outwardly from said filter media towards said channel such that each plate is positioned substantially within said channel, said plurality of plates facilitate the flow of the solid desiccant within said channel via gravity.

13. A system in accordance with claim 11, wherein said at least one filter element is substantially horizontal with respect to each of said first and said second end surfaces, said at least one filter element further comprises a rotating element positioned within said channel from said filter media first end to said filter media second end, wherein said rotating element is substantially spiral shaped and facilitates a rotational force to facilitate the flow of the solid desiccant within said channel.

14. A system in accordance with claim 9, further comprising a regenerator coupled to said turbine engine and to said air processing assembly, wherein said regenerator is configured to use exhaust gases or any other source of warm fluid to regenerate the solid desiccant.

15. A system in accordance with claim 9, wherein said regenerator is positioned within an exhaust section of said turbine engine.

16. A system in accordance with claim 9, wherein said channel defines a flowpath for a silica gel.

17. A method of processing air, said method comprises:
supplying air to an air processing assembly that includes at least one filter element positioned within the assembly, wherein said at least one filter element includes a filter media that includes a first end and a second end position a predefined distance from the first end;
channeling the air to the at least one filter element;
filtering the air when the air is channeled through at least a portion of the filter media;
channeling the air to a channel defined within the filter media, wherein the channel extends from the filter media first end to the filter media second end; and
distributing a solid desiccant within a flow path defined within the channel such that moisture is substantially removed via the solid desiccant.

18. A method in accordance with claim 17, further comprising:
channeling the air to a compressor of a turbine engine when the air has been filtered and moisture has been substantially removed from the air; and
cooling the air.

19. A method in accordance with claim 17, wherein distributing a solid desiccant further comprises distributing a solid desiccant via gravity and a plurality of plates that are coupled to the filter media, each plate extends outwardly from the filter media towards the channel such that each plate is positioned substantially within the channel.

20. A method in accordance with claim 19, wherein distributing a solid desiccant further comprises distributing a solid desiccant via a rotational force generated by a rotating element positioned within the channel from the filter media first end to the filter media second end.
